(19) United States
(12) Patent Application Publication
(10) Pub. No.: US 2002/0159612 A1
(43) Pub. Date: Oct. 31, 2002

(54) Personal computer audio interface device and method of using the same

(76) Inventor: Stan Kosciuk, Mountainside, NJ (US)

Correspondence Address: Brian K. Dinicola, 34 Avenue E, Monroe Twp, NJ, 08831, US

(21) Appl. No.: 09/844,909

(22) Filed: Apr. 27, 2001

(51) Int. Cl. H04R 5/00; H01P 5/12

(52) U.S. Cl. 381/306; 381/1; 381/77; 333/124

(57) ABSTRACT

An interface system for interconnecting a personal computer to audio input ports of a home stereo system. An illustrative embodiment of the invention comprises impedance transformers for improving the impedance match between an audio output port of the PC and the higher impedance audio input ports of the stereo system. An elongated low voltage, low impedance cable has coupling devices at each end, the coupling devices being dimensioned and arranged to establish respective signal paths through the cable by electrically interconnecting the audio output port and the corresponding low impedance windings of the first and second impedance transformers. The illustrative interface system further includes additional coupling devices dimensioned and arranged to accommodate electrical connections between corresponding high impedance windings of the first and second impedance transformers and the first and second audio input ports of the home stereo system.

### BACKGROUND OF THE INVENTION

1. Field of the Invention

The present invention relates generally to the audible reproduction of audio signals and, more particularly, to a system and method for converting the low impedance audio input of a personal computer into a format which enables the same to be audibly reproduced by a conventional home stereo system.

2. Discussion of the Prior Art

There has been a recent trend toward multimedia computing wherein the inputs and outputs of personal computers (PC's) are more than just text or still diagrams and drawings. Indeed, computers having multimedia capability are often quite sophisticated, containing high resolution video cards, sound cards, compact disc readers, digital video disc players and recorders, and even special TV adapter cards enabling the user to watch TV broadcasts on the PC monitor. With new sources of audio files and content being added to the worldwide web every day, the need for flexibility in the personal computer's audio output capability would seem axiomatic. Unfortunately, however, the typical user seeking to take advantage of the multimedia PC has surprisingly limited options, at least with respect to the audio output thereof.

The sound card installed in a conventional PC typically has one or more standard low impedance (i.e., 8Ω) output port(s), which are suitable for driving headphones and small external speakers dimensioned for placement on the user's desktop. Disadvantageously, these small speakers tend to have poor frequency response, particularly at the lower frequencies of the audible range. Recognizing this deficiency, various techniques have been proposed to interconnect the output of the PC soundcard to the speakers of a conventional home stereo or home entertainment system. It is possible, for example, to purchase a cable having a mini-headphone jack on one end (for connection to the sound card output port), and two dual RCA plugs on the other end (for connection, for example, to the auxiliary input of the home stereo's amplifier/receiver). Provided the sound card has a stereo output having a signal-to-noise ratio (SNR) of at least 85 dB and the distance is relatively short (i.e., no more than ten to twelve feet or so), such a cable may provide acceptable results. Unfortunately, however, the personal computer in most cases will be so far away from the home stereo system as to make the audio output garbled and/or imperceptible. Also, the voltage level of the sound card may not be appropriate for the stereo system, causing signal distortion and/or low volume. If there is also a mismatch between the respective grounds of the PC and home stereo system chassis, there can be a substantial amount of power line hum. The inventor herein presumes that this is the reason cables of this type are not commercially available in lengths greater than twelve feet.

A need therefore exists for an interface which would enable a multimedia PC user to audibly reproduce the output of the PC using a home stereo system, regardless of the distance separating them in the home.

### SUMMARY OF THE INVENTION

The aforementioned need is addressed, and an advance is made in the art, by an interface system for interconnecting an audio output port of a personal computer to first and second audio input ports of a home stereo system, each of the first and second audio input ports being characterized by a substantially higher input impedance than the output impedance of the audio output port. An illustrative embodiment of the invention comprises a first impedance transformer for improving an impedance match between the audio output port and the first audio input port, and a second impedance transformer for improving an impedance match between the audio output port and the second audio input port. An elongated low voltage and low impedance cable has coupling devices at each end, the coupling devices being dimensioned and arranged to establish respective electrical signal paths through the cable to thereby electrically interconnect the audio output port and the corresponding low impedance winding of the first and second impedance transformers. The illustrative interface system further includes additional coupling devices dimensioned and arranged to accommodate electrical connections between corresponding high impedance windings of the first and second impedance transformers and the first and second audio input ports of the home stereo system.

Using low impedance cable in accordance with the present invention has several key advantages. First, it allows for a low cost installation using commercially available, off-the-shelf components and inexpensive, unshielded cable. Second, power line hum is not a factor because of the low impedance levels along the signal path. Finally, it may be possible to use existing low impedance wiring (e.g., unused telephone wires pairs) within the walls of the home.

### BRIEF DESCRIPTION OF THE DRAWINGS

The various features and advantages characterizing the novelty of the present invention will become more evident upon reading the following description of the illustrative embodiment in conjunction with the accompanying drawings, in which:

FIG. 1 is a schematic representation of a personal computer having its audio output coupled to the audio input(s) of a home stereo system in accordance with the teachings of the present invention;

FIG. 2 is a block diagram depicting the use of an interface incorporating impedance converters to drive a home stereo system with the output of a PC audio source, according to the present invention;

FIG. 3A is an electrical circuit diagram depicting in greater detail the interior interconnections of an interface constructed in accordance with an illustrative embodiment of the present invention;

FIG. 3B is an exterior perspective view depicting the output ports of the exemplary embodiment of FIG. 3A;

FIG. 3C is an exterior perspective view depicting the input port of the exemplary embodiment of FIG. 3A; and

FIG. 3D is a perspective view of a mating assembly which may be used in conjunction with a modified embodiment of the present invention.

### DETAILED DESCRIPTION OF THE INVENTION

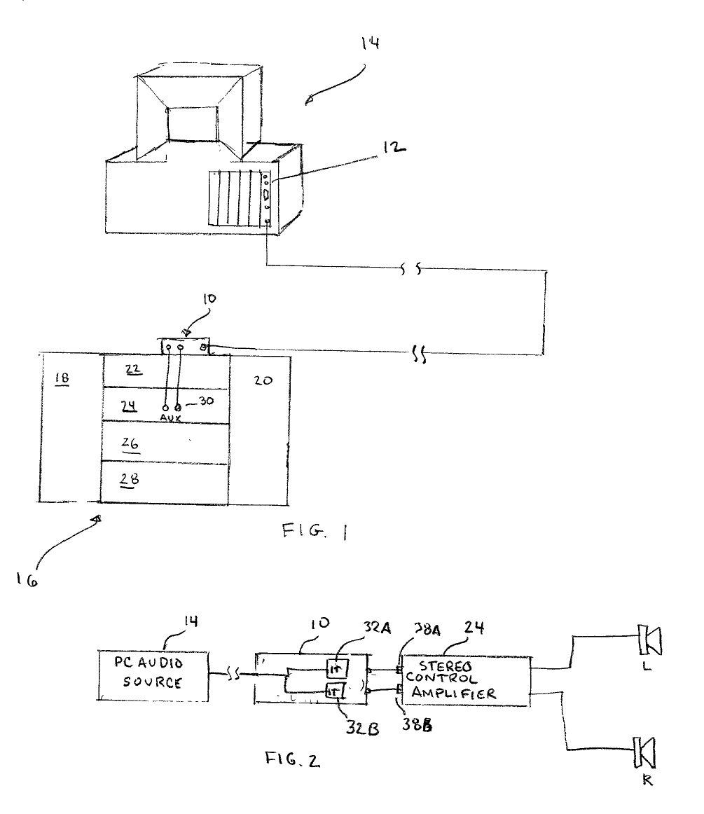

With initial reference to the block diagram of FIG. 1, in accordance with the invention, an audio interface system 10 is provided for establishing a robust audio signal path between the sound card 12 of a personal computer 14 and a remotely located home entertainment system including a stereo unit indicated generally at reference numeral 16. As will be readily appreciated by those skilled in the art, a conventional stereo system generally includes a pair of speakers 18 and 20, a cassette player 22, a stereo control amplifier 24, a stereo synthesizer tuner 26, and a CD player 28. Typically, the aforementioned stereo system components—which represent respective sources of audio output—are connected to corresponding ports of the stereo control amplifier, through which any of them may drive the connected speaker units as speaker units 18 and 20.

To accommodate additional input audio signals such as from a television, VCR, or the like, the stereo control amplifier 24 generally includes one or more additional pairs (i.e., left and right IN) of input ports 30, which may be designated as auxiliary (AUX) ports. Advantageously, the input audio signals provided in accordance with the present invention may be readily supplied to the stereo system 16 via such auxiliary ports. Alternatively, however, a set of ports associated with an under or non-utilized piece of equipment might be used instead.

In any event, it will be readily appreciated by those skilled in the art that the input impedance for a conventional home stereo is something on the order of from about 20 to 50 kilo-ohms (kΩ). In contrast, the output from a typical personal computer soundcard is generally matched to the impedance of the loudspeaker—which may range from 4-16Ω over the audio power frequency range. The inventor herein has recognized that while it is possible to audibly reproduce signals output by the sound card 12 of a personal computer as personal computer 14, such reproduction may be practical at a reasonable fidelity over only relatively short distances (i.e., less than around 20 feet), and otherwise subject to hum and distortion, unless certain steps are taken in accordance with the present invention. Specifically, and as best seen in FIG. 2, it is necessary to provide an impedance transformer for each signal (e.g., left and right speaker signals as shown in FIG. 2 would require two impedance transformers, 32A and 32B).

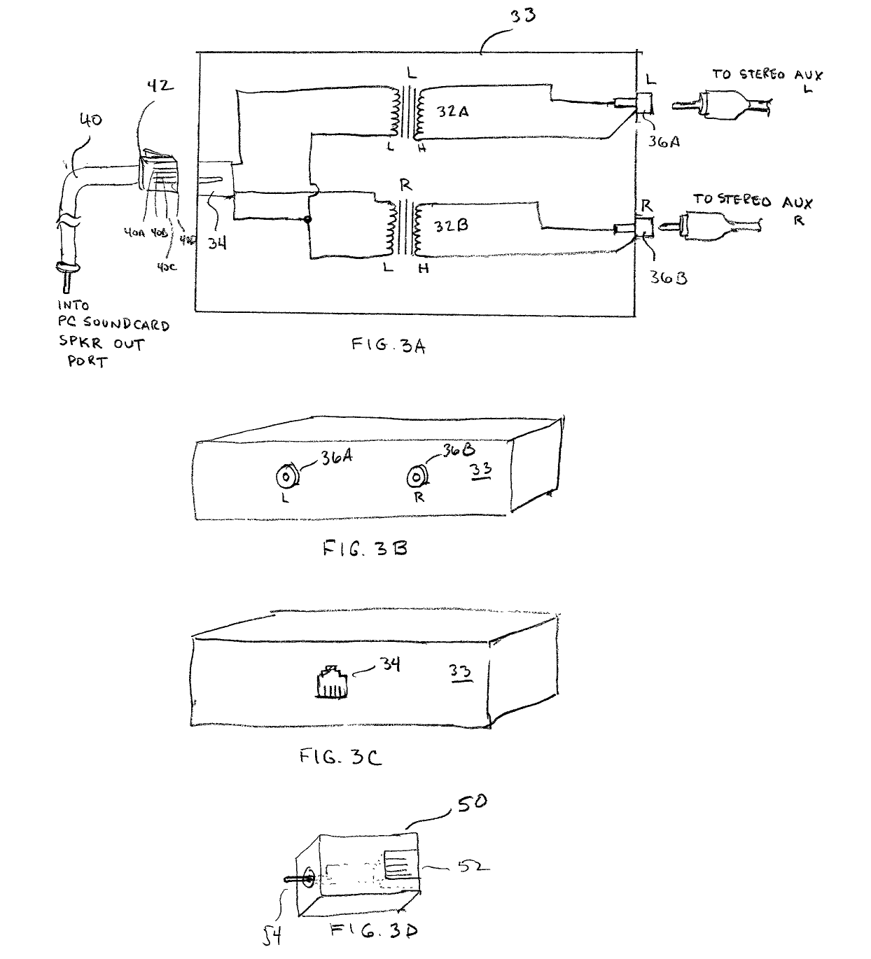

Turning now to FIG. 3A, there is shown in greater detail the internal construction of an exemplarty interface unit 10 incorporating impedance transformers in accordance with the present invention. In the illustrative embodiment of FIG. 3A, in which an output suitable for driving two speakers via a stereo control amplifier or the like is contemplated, a first impedance transformer and a second impedance transformer within a housing 33—each having a low impedance winding L electrically connectable to corresponding output coupling devices indicated generally at 36A and 36B, respectively. Essentially, each impedance transformer serves to match the impedance of the signal source, i.e., the sound card 12 and the home stereo input ports 38A and 38B (FIG. 2) of AUX input 30 (FIG. 1) in order to minimize distortion. To minimize signal losses and further minimize distortion, an especially preferred embodiment of the present invention contemplates that transmission of the audio signal from the personal computer is done over low impedance, low voltage electrical paths. A suitable transmission path may be readily implemented using a ubiquitous, commercially available cable such as the low voltage, indoor rates, four conductor (red, green, yellow and black color insulation) telephone cable 40 typically used in residential telephony applications. The illustrative embodiment of FIGS, 3A-3C depict such a configuration.

As best seen from simultaneous reference to FIGS. 3A and 3C, the input port 34 of the interface 10 is conveniently realized as a standard RJ11 female telephone jack dimensioned and arranged to establish respective electrical communication paths with each conductor 40A-40D of cable 40 when the male RJ11 connector 42 terminating one end of cable 40 is inserted therein. It will, of course, be readily appreciated by those skilled in the art that a wide variety of coupling devices and cable configurations may be employed without departing from the spirit and scope of the invention. The embodiment of FIGS. 3A-3C simply represents one low cost solution based upon inexpensive, commercially available components. In keeping with that objective, the high impedance windings H of interface 10 are, preferably, likewise connected to respective coupling devices 36A and 36B of a commercially available nature. Specifically, and as best seen in FIG. 3B, coupling devices 36A and 36B are advantageously realized, in this embodiment, as standard female RCA jacks to accommodate a conventional attachment to identical jacks of the home stereo system using cables equipped with standard male-male terminations, as suggested in FIG. 3A.

Although as mentioned above, it is an objective of the present invention to utilize commercially available, low cost components to the extent possible, it will be readily appreciated by those skilled in the art that conventional PC soundcards are generally not commercially available with a female RJ11 jack for attachment to the illustrative cable 40 previously described in conjunction with the illustrative embodiment of FIG. 3A. Accordingly, it is necessary either to modify the other end of cable 40 to incorporate a miniature male speaker out jack of the type dimensionally and electrically compatible with a standard PC soundcard, utilize a PC soundcard specifically modified to provide a female RJ11 speaker output port, or utilize a different cable/conductor design such as one having the standard miniature male jack at both ends and modify the interface 10 to accommodate the same. While the latter option might seem the most attractive, cables of this type are not today commercially available in the lengths contemplated by the inventor herein as separating the PC and typical home stereo system. A fourth alternative is exemplified in FIG. 3D and involves the use of a mating assembly 50 having a female RJ11 jack 52 for accommodating the other end of a standard residential telephone cable used as elongated low impedance cable 40, so that both ends of cable 40 are identically equipped with a male RJ11 terminating connector. Mating assembly 52 further includes a male miniature speaker jack 54 dimensioned and arranged for insertion into the speaker input of PC sound card 12, the jacks 52 and 54 being electrically coupled to provide the requisite electrical connectivity between the conductors of cable 40 and the appropriate signal terminations within the audio output port of sound card 12.

The arrangement of the present invention, as disclosed above, thereby provides a system that overcomes the problems, such as distortion, of known systems without requiring such expedients as wireless transmission using complex RF signal converters and expensive active components. The interface system may, as has been described, be comprised of conventional, commercially available devices, thereby reducing its cost. It will be further appreciated by those skilled in the art the interface of the present invention acts as a buffer between the personal computer and the home stereo system components. Accordingly, in situations where direct connections do not work well because of any incompatibilities between specific personal computer hardware and stereo system components, even at short distances the interface of the present invention can provide tangible benefits. That is, by connecting such components and hardware via the interface of the present invention, it is possible to isolate them from one another and ameliorate the effects of electrical incompatibilities.

Although the present invention has been described with reference to illustrative embodiments, it will be apparent to those skilled in the art that variations and modifications are contemplated within the spirit and scope of the invention. The drawings and description of the preferred embodiments are made by way of example rather than to limit the scope of the invention, and it is intended to cover within the spirit and scope of the invention all such changes and modifications.

What is claimed is:

1. An interface system for interconnecting an audio output port of a personal computer to first and second audio input ports of a home stereo system, each of said first and second audio input ports being characterized by a substantially higher input impedance than an output impedance of said audio output port, comprising:
a housing;
a first impedance transformer disposed within said housing for improving an impedance match between said audio output port and said first audio input port;
a second impedance transformer disposed within said housing for improving an impedance match between said audio output port and said second audio input port;
a multiple conductor elongated cable having a first coupling device at one end thereof and a second coupling device at another end thereof, said first and second coupling devices being dimensioned and arranged to establish respective electric signal paths through said cable by electrically interconnecting said audio output port and corresponding low impedance windings of said first and second impedance transformers; and
third and fourth coupling devices mounted on said housing, said third and fourth coupling devices being dimensioned and arranged to accommodate electrical connections between corresponding high impedance windings of said first and second impedance transformers and the first and second audio input ports of said home stereo system.

2. The interface of claim 1, wherein said first coupling device comprises a standard male miniature speaker connector.

3. The interface of claim 2, wherein said elongated cable comprises a section of low voltage, four conductor telephone cable, wherein said second coupling device is a male RJ11-type telephone connector, and wherein said first coupling device further includes a male RJ11-type telephone connector and a mating assembly having a female RJ11 jack and a male miniature speaker jack, said mating assembly, first coupling device and second coupling device being operative to establish respective electrical paths between said audio output port and at least three conductors of said four conductor telephone cable.

4. The interface of claim 2, wherein said elongated cable comprises a section of low voltage, four conductor telephone cable and wherein said second coupling device is a male RJ11-type telephone connector.

5. The interface of claim 1, wherein said third and fourth coupling devices are standard RCA female connectors, each electrically coupled to a high impedance winding of a corresponding one of said first and second impedance transformers.

6. The interface of claim 1, wherein an impedance ratio between said high impedance winding and said low impedance winding is between from 1000:1 to 5000:1.

7. The interface of claim 1, wherein each conductor of said elongated multiple conductor cable has an impedance of between 4 and 16 ohms.

8. A method of audibly reproducing audio signals originating at a personal computer using a remotely located home stereo system, comprising the steps of:
supplying, via an elongated low impedance cable, audio signals output by a personal computer to at least one impedance transformer remotely located from said personal computer, said impedance transformer being operative to improve an impedance match between an audio output port of said personal computer and at least one input audio port of said home stereo system; and
electrically coupling an output of said at least one impedance transformer to an input audio port of said home stereo system.

9. The method of claim 8, wherein said low impedance cable comprises a low voltage, four conductor telephone cable.

10. The method of claim 8, wherein said electrically coupling step includes connecting a RCA male connector of a first end of a second cable to a high impedance winding of said at least one impedance transformer and a RCA male connector of a second end of the second cable to said at least one input audio port of said home stereo system.

11. The method of claim 8, wherein the elongated cable supplied during said supplying step is at least 25 feet along.

12. The method of claim 8, wherein the elongated cable employed during said supplying step comprises a four-conductor section of residential telephone cable having a transmission line impedance of 8 ohms.

13. The method of claim 12, wherein the elongated cable employed during said supplying step has a male RJ11 connector electrically coupled to at least one end thereof.

14. An interface system for interconnecting an audio output port of a personal computer to at least one audio input port of a home stereo system via an elongated low impedance cable having first and second coupling devices at first and second ends thereof, respectively, said at least one audio input port being characterized by a substantially higher input impedance than an output impedance of said audio output port, comprising:
a housing;
at least one impedance transformer disposed within said housing for improving an impedance match between said audio output port and said at least one audio input port;
a low impedance connector mounted on said housing and adapted to establish respective electrical signal paths through the cable by electrically interconnection said audio output port and a corresponding low impedance winding of said at least one impedance transformer; and
at least one high impedance connector mounted on said housing and adapted to establish a respective signal path between a corresponding high impedance winding of said at least one impedance transformer and said at least one audio input port of said home stereo system.

15. The interface system of claim 14, wherein the home stereo system includes first and second high impedance audio input ports and wherein said interface includes first and second impedance transformers and first and second high impedance connectors, each of said first and second high impedance connectors being electrically coupled to a corresponding high impedance winding of a respective impedance transformer and electrically connectable to a corresponding one of said first and second high impedance audio input ports.
